(19) United States
(12) Patent Application Publication
(10) Pub. No.: US 2022/0206115 A1
(43) Pub. Date: Jun. 30, 2022

(54) DETECTION AND RANGING OPERATION OF CLOSE PROXIMITY OBJECT

(71) Applicant: Beijing Voyager Technology Co., Ltd., Beijing (CN)

(72) Inventors: Vipul Chawla, Mountain View, CA (US); Lingkai Kong, Palo Alto, CA (US); Yue Lu, Mountain View, CA (US); John K. Wu, Mountain View, CA (US)

(21) Appl. No.: 17/137,224

(22) Filed: Dec. 29, 2020

(51) Int. Cl. G01S 7/484; G01S 17/10; G01S 17/931

(52) U.S. Cl. CPC G01S 7/484; G01S 17/931; G01S 17/10

(57) ABSTRACT

In one example, an apparatus is provided. The apparatus is part of a Light Detection and Ranging (LiDAR) module and comprises a transmitter circuit, a receiver circuit, and a controller. The receiver circuit comprises a photodetector configured to convert a light signal into a photocurrent signal. The controller is configured to: transmit, using the transmitter circuit, a first light signal; receive, using the photodetector of the receiver circuit, a second light signal; determine whether the second light signal includes a scatter signal coupled from the transmitter circuit, and a reflected first light signal; and based on whether the second light signal includes the scatter signal and the reflected first light signal, determine a time-of-flight of the first light signal based on one of: a width of the second light signal, or a time difference between the transmission of the first light signal and the reception of the second light signal.

### BACKGROUND

Object detection and ranging operations generally refer to detecting the presence of an object at a certain distance from an observer, and measuring the distance. Object detection and ranging operations can be found in many applications, such as in a collision avoidance system of a vehicle, among many others.

An object detection operation can be performed based on transmission of a signal (e.g., a light signal) into the space and monitoring for the reflected signal, whereas a ranging operation can be performed using various techniques including, for example, measuring time-of-flight of signals propagating between the observer and the object. Specifically, a transmitter of the observer can transmit a signal, such as a light signal, at a first time. If the object is present, the signal can reach and be reflected off the object, and the reflected light signal can be detected by a receiver of the observer at a second time. Detection of the reflected light signal can indicate the presence of the object. Moreover, the difference between the first time and the second time can represent a total time-of-flight of the signal. Based on the speed of propagation of the signal, as well as the time-of-flight of the signal, the distance between the observer and the object can be determined.

To improve the accuracy of the object detection and ranging operation, the receiver may include pre-processing circuit, such as amplifier and analog-to-digital converter (ADC), to perform pre-processing of the received signals. The pre-processing, which can include amplification and digitalization, can prepare the signals for subsequent processing operations to match a received signal with a transmitted signal. The matching enables a determination that the received signal is a reflected signal from an object. Moreover, a time-of-flight of the signal can be determined based on a difference between the transmission time of the signal and the reception time of the reflected signal, to determine a distance between the receiver and the object.

The receiver, as well as the pre-processing circuit, typically have a dynamic range for which the output is linearly related to the input. If the signal level of the reflected signal exceeds the upper limit of the dynamic range, the receiver and/or the pre-processing circuit (e.g., the amplifier) may become saturated by the reflected signal, which introduces non-linearity in the output of the pre-processing circuit. The non-linearity can cause erroneous matching between the transmitted and received signals, which can introduce errors to the ranging operation.

### BRIEF SUMMARY

In one example, an apparatus is provided. The apparatus is part of a Light Detection and Ranging (LiDAR) module of a vehicle. The apparatus comprises a transmitter circuit, a receiver circuit, and a controller. The receiver circuit comprises a photodetector configured to convert a light signal into a photocurrent signal. The controller is configured to: transmit, using the transmitter circuit, a first light signal; receive, using the photodetector of the receiver circuit, a second light signal; determine whether the second light signal includes a scatter signal coupled from the transmitter circuit, and a reflected first light signal; and based on whether the second light signal includes the scatter signal and the reflected first light signal, determine a time-of-flight of the first light signal based on one of: a width of the second light signal, or a time difference between the transmission of the first light signal and the reception of the second light signal.

In some aspects, the receiver circuit comprises an amplifier configured to convert the photocurrent signal into a voltage signal. The controller is configured to determine the width of the second light signal based on a width of the voltage signal or a width of the photocurrent signal.

In some aspects, the width of the second light signal is determined based on a threshold signal level. The threshold signal level is based on a minimum signal level of the second light signal received from an object at a maximum distance for which the second light signal includes the scatter signal and the reflected first light signal.

In some aspects, the minimum signal level is determined based on a minimum reflectivity of the object to be detected.

In some aspects, the controller is configured to determine whether the second light signal includes the scatter signal and the reflected first light signal based on comparing the width of the second light signal with a threshold signal width of the scatter signal.

In some aspects, the controller maintains a first mapping between different widths of the second light signal and different time-of-flights. The controller is configured to determine the time-of-flight based on the first mapping.

In some aspects, the controller is configured to: determine a first width of the second light signal; determine a second width of the scatter signal; determine a degree of width change of the second light signal based on a difference between the first width and the second width; and determine the time-of-flight based on the degree of width change.

In some aspects, the controller maintains a second mapping that maps different degrees of width change of the second light signal to different time-of-flights. The controller is configured to determine the time-of-flight based on the second mapping.

In some aspects, the controller is configured to: receive a third light signal corresponding to the scatter signal; and determine a time difference between the third light signal and the second light signal for the time difference between the transmission of the first light signal and the reception of the second light signal.

In some aspects, the controller is configured to: determine a first time when a first edge of the third light signal crosses a threshold; determine a second time when a second edge of the second light signal crosses the threshold; and determine the time difference based on the first time and the second time.

In some aspects, the controller is configured to: determine that the second light signal includes the scatter signal but not the reflected first light signal; and based on determining that the second light signal includes the scatter signal but not the reflected first light signal, transmit, using the transmitter circuit, a third light signal. A signal level of the third light signal is higher than a signal level of the first light signal.

In some aspects, the signal level of the first light signal is based on an eye safety requirement.

In some aspects, the receiver circuit further includes a time-to-digital converter (TDC). The width of the second light signal is determined based on outputs of the TDC.

In some aspects, the photodetector comprises at least one of: an avalanche photodiode (APD), a single-photon avalanche diode (SPAD), or a silicon photomultiplier (SiPM).

In some examples, a method is provided. The method comprises: transmitting, by a transmitter circuit of a Light Detection and Ranging (LiDAR) module, a first light signal; receiving, by a photodetector of a receiver circuit of the LiDAR module, a second light signal; determining, by a controller of the LiDAR module, whether the second light signal includes a scatter signal coupled from the transmitter circuit, and a reflected first light signal; and based on whether the second light signal includes the scatter signal and the reflected first light signal, determining a time-of-flight of the first light signal based on one of: a width of the second light signal, or a time difference between the transmission of the first light signal and the reception of the second light signal.

In some aspects, the receiver circuit comprises an amplifier configured to convert a photocurrent signal output by the photodetector in response to the second light signal into a voltage signal. The width of the second light signal is determined based on a width of the voltage signal or based on a width of the photocurrent.

In some aspects, the width of the second light signal is determined based on a threshold signal level. The threshold signal level is based on a minimum signal level of the second light signal received from an object at a maximum distance for which the second light signal includes the scatter signal and the reflected first light signal.

In some aspects, the method further comprises: determining a first width of the second light signal; determining a second width of the scatter signal; determining a degree of width change of the second light signal based on a difference between the first width and the second width; and determining the time-of-flight based on the degree of width change.

In some aspects, the method further comprises: receiving a third light signal corresponding to the scatter signal; and determining a time difference between the third light signal and the second light signal for the time difference between the transmission of the first light signal and the reception of the second light signal.

In some aspects, the method further comprises: determining that the second light signal includes the scatter signal but not the reflected first light signal; and based on determining that the second light signal includes the scatter signal but not the reflected first light signal, transmitting, using the transmitter circuit, a third light signal. A signal level of the third light signal is higher than a signal level of the first light signal.

### BRIEF DESCRIPTION OF THE DRAWINGS

The detailed description is set forth with reference to the accompanying figures.

FIG. 1 shows an autonomous driving vehicle utilizing aspects of certain embodiments of the disclosed techniques herein.

FIG. 2A, FIG. 2B, and FIG. 2C illustrate examples of a ranging system that can be part of FIG. 1 and its operations.

FIG. 3A and FIG. 3B illustrate examples of non-idealities that can affect detection and ranging operation for a close proximity object.

FIG. 4A, FIG. 4B, FIG. 4C, and FIG. 4D illustrate example techniques to perform detection and ranging operation for a close proximity object.

FIG. 5A, FIG. 5B, FIG. 5C, FIG. 5D, and FIG. 5E illustrate example techniques to perform detection and ranging operation for a close proximity object.

FIG. 6 illustrate an example of a multi-signal transmission operation to support an object detection and ranging operation.

FIG. 7 illustrates a flowchart of a method of performing an object detection and ranging operation, according to certain examples.

### DETAILED DESCRIPTION

In the following description, various examples of a ranging system will be described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

An objection detection and ranging system, such as a Light Detection and Ranging (LiDAR) module, typically includes a transmitter and a receiver. The transmitter can transmit one or more light signals (e.g., laser pulses) into the space, whereas the receiver can receive light signals. The LiDAR module also typically includes a digital signal processor to process the received light signals, and a controller to perform the object detection and ranging operation based on a result of the processing. The processing may include, for example, extracting amplitude characteristics (e.g., a shape), frequency content, etc., of the received signals. Based on the result of the processing, the controller can match the received signal and the transmitted signal (e.g., based on having the same amplitude envelops, same frequency contents, etc.) to identify pairs of transmitted and received signals. The matching enables the controller to determine that the received signal is a reflected signal from an object. The controller can then determine a time-of-flight of the signal based on a time difference between the corresponding points (e.g., peaks) of the transmitted signal and the reflected signal of the pair, to determine a distance between the receiver and the object.

To improve the accuracy of the object detection and ranging operation, the receiver may include a pre-processing circuit to perform pre-processing of the received signals. The pre-processed signals can then be processed to extract amplitude and/or frequency information. The pre-processing circuit typically includes an amplifier to amplify the received signals, and an analog-to-digital converter to perform digitalization of the amplified signals to generate digital values.

The receiver, as well as the pre-processing circuit, such as the amplifier and the ADC, typically have a dynamic range for which the output is linearly related to the input. The lower end of the dynamic range can be related to, for example, the noise floor of the input signal and/or the detector and/or the pre-processing circuit. If the input signal level is below the lower end of the dynamic range, the pre-processing circuit may be unable to distinguish the input from noise. The upper end of the input range can be related to, for example, an input signal level which causes the amplifier and the ADC to saturate. If the input signal level is above the upper end of the dynamic range, the output of the pre-processing circuit may stay at the saturation level and no longer correlates with the input. The problem of saturation can become worsened if the amplification gain of the pre-processing circuit is increased to increase the lower end of the dynamic range, which enables detection of weak reflected signals from afar, to increase the maximum distance of the object detection and ranging operation. With an increased amplification gain, as the signal level of the output increases for the same input signal level, it becomes easier for the amplifier to be saturated by the input.

The saturation of the pre-processing circuit may introduce non-linearity to the output, such that the output is no longer linearly related to actual reflected light signal. Non-linearity can distort the pre-processed reflected signal, which can also introduce error to the ranging operation. Specifically, while a reflected signal may have the same amplitude characteristics and/or frequency contents as the transmitted signal, due to distortion the pre-processed reflected signal may no longer have the same amplitude characteristics and/or frequency contents as the transmitted signal. As a result, the reflected and the transmitted signals may not be paired for time-of-flight determination. Moreover, even if a correct pair of transmitted and reflected signals is identified, due to distortion the controller may be unable to properly identify the corresponding points (e.g., peaks) between the transmitted and reflected signals, which can introduce uncertainty in the time-of-flight determination.

The detection and ranging operation for a nearby object that is in a close proximity to the observer (e.g., an object within one meter from the observer) can be especially susceptible to saturation. This is because reflected signals from a nearby object typically experience very little attenuation and can have a very high signal level when reaching the input of the receiver. The reflected signals may saturate the pre-processing circuit as a result. Moreover, the transmitted signal may become coupled into the input of the receiver via, for example, scattering by the optical components, by the chassis, etc. The scatter signal can also saturate the pre-processing circuit. Furthermore, as the scatter signal and the reflected light signal from the nearby object may arrive at the receiver at around the same time, the pre-processed scatter signal and pre-processed reflected signal, output by the pre-processing circuit, may overlap. Combined with the fact that the signals saturate the pre-processing circuit, the pre-processing circuit outputs can become so distorted that they become unrecognizable from the reflected signal. This makes it challenging to perform accurate detection and ranging operation of nearby objects. On the other hand, accurate detection and ranging operation of nearby objects is critical for collision avoidance and safety.

### Conceptual Overview of Examples of the Present Disclosure

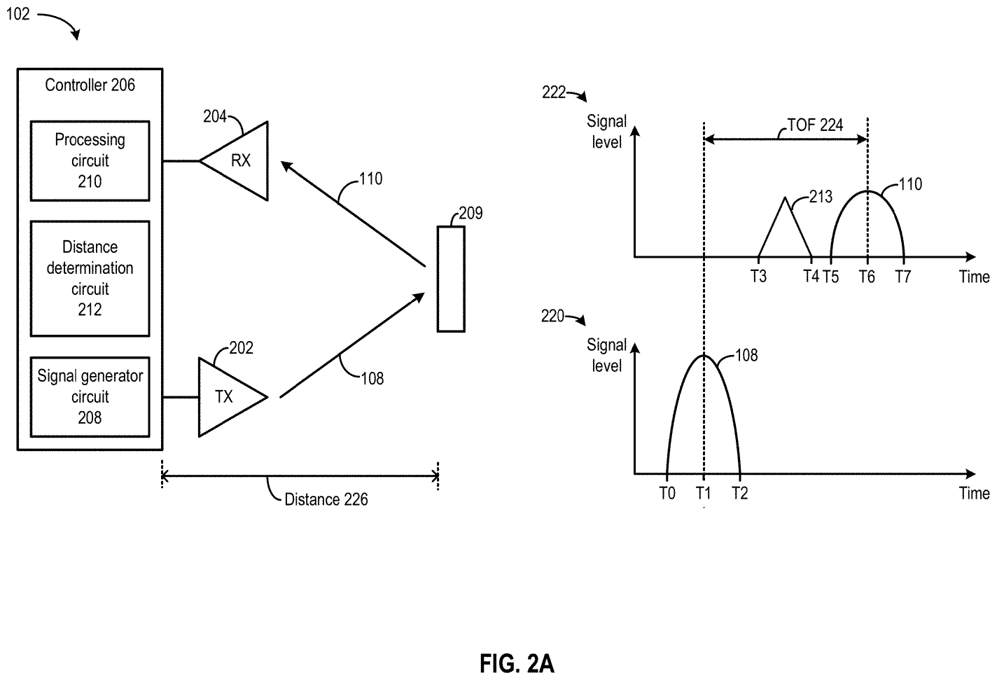

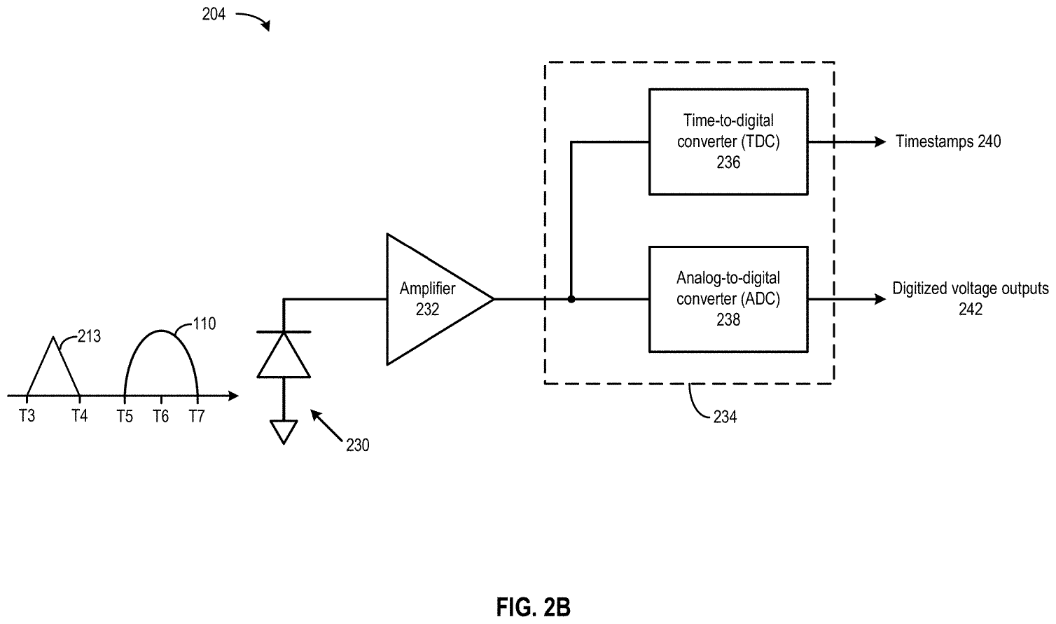

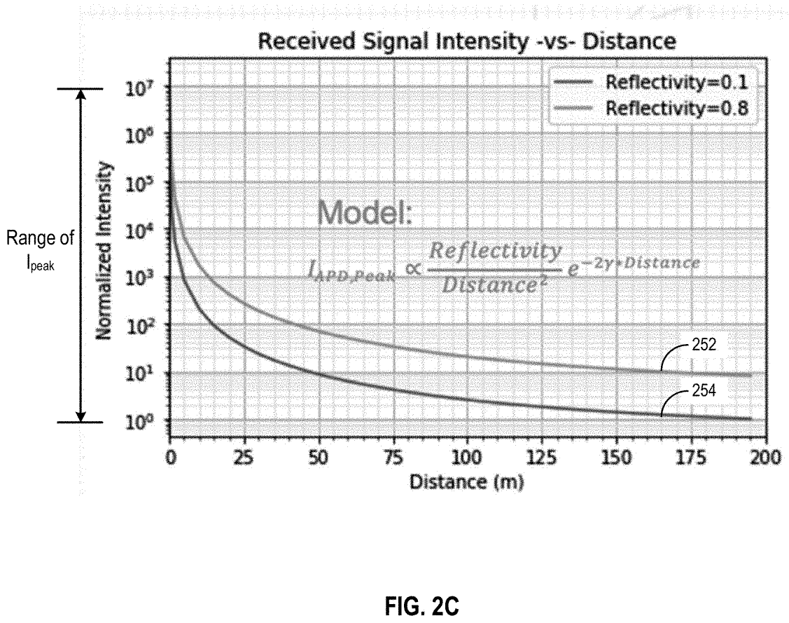

Examples of the present disclosure relate to a detection and ranging system, such as a LiDAR module, that can address the problems described above. Referring to FIG. 2A-FIG. 2C, various examples of a LiDAR module can include a transmitter circuit, a receiver circuit, pre-processing circuit including an amplifier, and a controller. The controller can control the transmitter circuit to transmit a first light signal. The receiver can receive a second light signal. The controller can control the amplifier of the pre-processing circuit to amplify the second light signal to generate a pre-processed second light signal. The controller can determine, based on the second light signal, or based on the pre-processed second light signal, whether the second light signal includes the reflected first light signal, as well as a scatter signal coupled from the transmitter circuit. If the controller determines that the second light signal includes the scatter signal and the reflected first light signal, the controller can determine a time-of-flight of the first light signal between the LiDAR module and an object based on a width of the second light signal (or the pre-processed second light signal). On the other hand, if controller determines that the second light signal includes the reflected first light signal but not the scatter signal, the controller can determine the time-of-flight of the first light signal based on a time difference between the transmission of the first light signal and the reception of the second light signal.

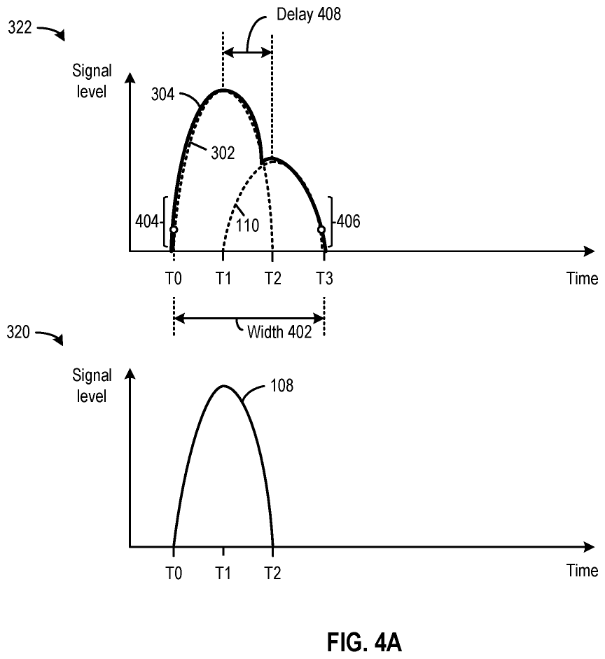

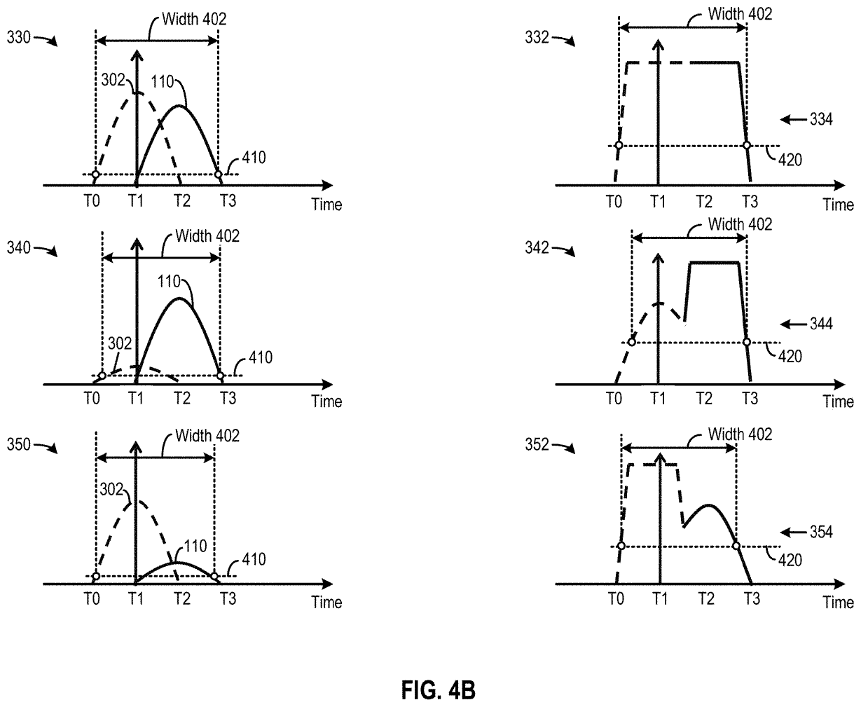

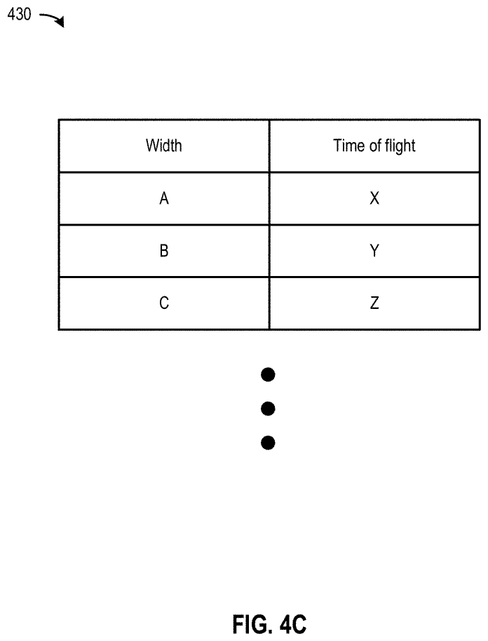

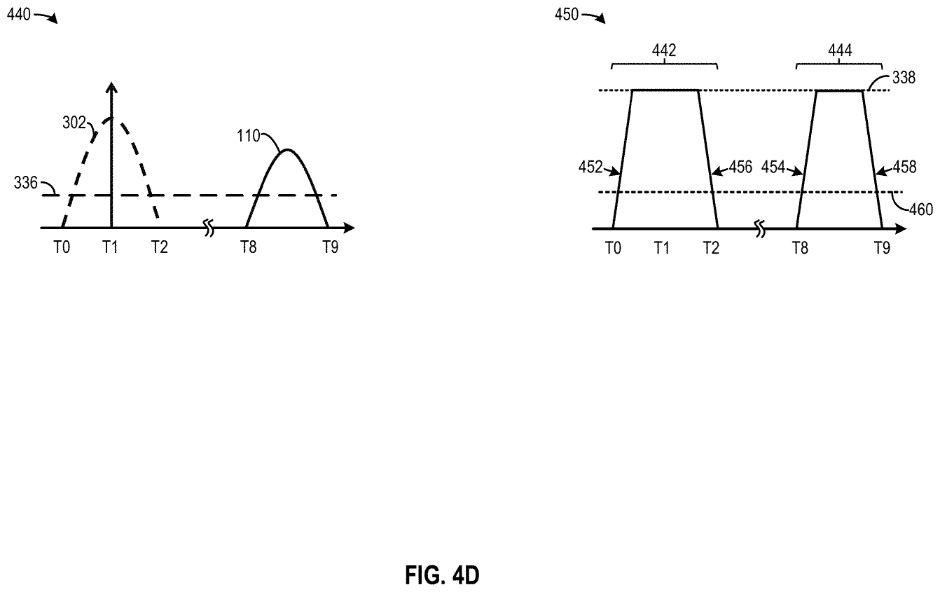

Specifically, referring to FIG. 4A, the scatter signal can be caused by the coupling of the first light signal from the transmitter circuit into the receiver circuit. Therefore, the receiver may receive the scatter signal at around the same time when the transmitter transmits the first light signal. If the first light signal is reflected from a nearby object, the reflected first light signal may arrive at the receiver soon after the scatter signal (and the transmission of the first light signal), and a part of the scatter signal can overlap with at least part of reflected first light signal to become the second light signal. The leading edge of the second light signal can correspond to the leading edge of the scatter signal/first light signal, whereas the trailing edge of the second light signal can correspond to the trailing edge of the reflected first light signal. As the time difference between the leading edge of the second light signal and the trailing edge of the second light signal is related to the delay between the scatter signal/first light signal and the reflected first light signal, the time-of-flight of the first light signal can also be derived from the width of the second light signal.

The controller can determine the time-of-flight of the first light signal based on measuring the width of the second light signal at the output of the photodetector, or based on measuring the width of the amplified second light signal at the output of the amplifier. For example, referring to FIG. 4B, the pre-processing circuit, such as a time-to-digital converter (TDC), can measure a first time when the leading edge of the second light signal (or the amplified second light signal) crosses a threshold, and a second time when the trailing edge of the second light signal (or the amplified second light signal) crosses the threshold. The width of the second light signal can then be determined based on the difference between the first time and the second time. The threshold can be set based on, for example, the minimum signal level of the second light signal (or the amplified second light signal) to be detected for a particular operation condition, to ensure that the leading and trailing edges of second light signal, at the outputs of the photodetector and of the amplifier, cross the threshold. In one example, referring to FIG. 4C, the controller can maintain a mapping between different widths of the second light signal and different time-of-flights, which can be determined by simulation and/or a calibration operation at the LiDAR module. The controller can then refer to the mapping to determine the time-of-flight of the first light signal for a particular width of the second light signal.

On the other hand, as shown in FIG. 4D, if the first light signal is reflected from a faraway object, the reflected first light signal may arrive at the receiver circuit at a relatively long time after the scatter signal. In such a case, the receiver may receive the reflected first light signal as the second light signal which does not include the scatter signal. The controller can then determine the time-of-flight based on a time difference between the first light signal and the second light signal, based on the outputs of the amplifier. The time difference can be determined based on, for example, a time difference between a pair of corresponding edges (e.g., a pair of leading edges, a pair of trailing edges, etc.) of the scatter signal and the second light signal, a time difference between corresponding points (e.g., peaks, middle points, etc.) of the scatter signal and the second light signal, etc.

The controller can determine whether the second light signal includes the reflected first light signal and the scatter signal using various techniques. In one example, the controller can compare the width of the pre-processed second light signal with a threshold width. The threshold width can represent the width of a standalone pre-processed reflected first light signal, the width of a standalone pre-processed scatter signal, etc. If the width of the pre-processed second light signal exceeds the threshold width, the controller can determine that the pre-processed second light signal includes not only the reflected first light signal but also the scatter signal, and the width of the pre-processed signal can be used to determine the time-of-flight.

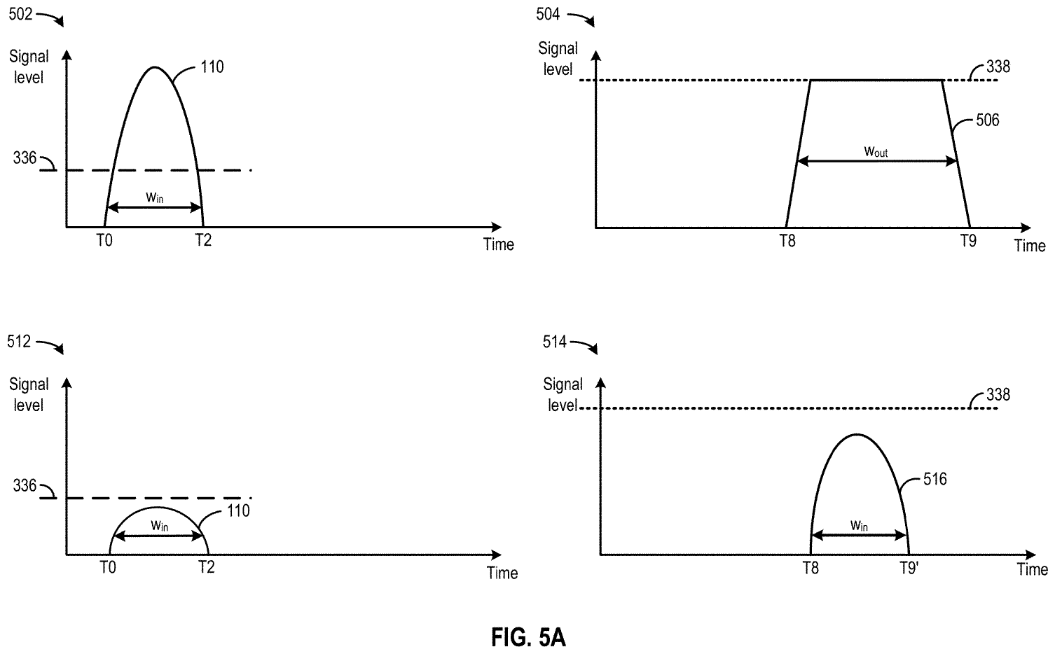

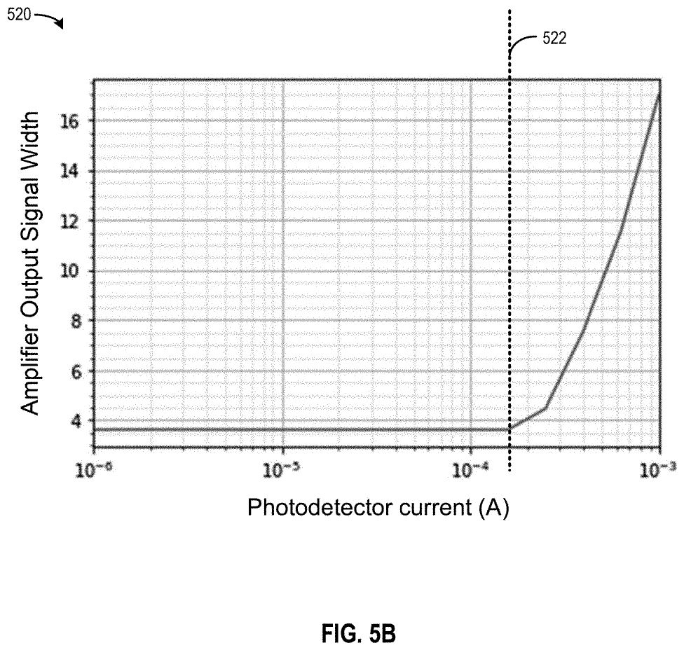

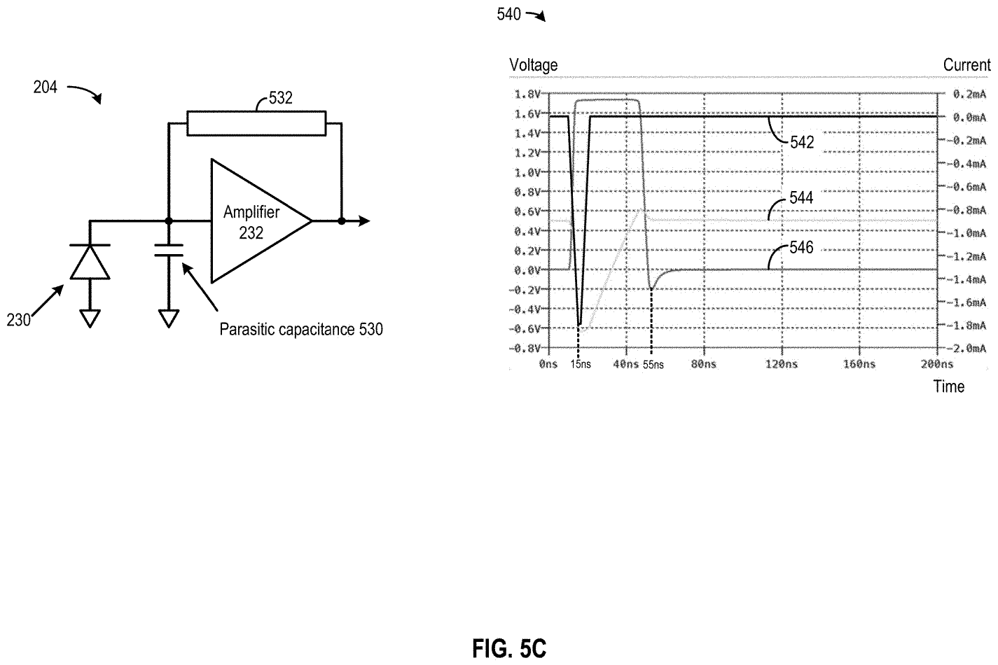

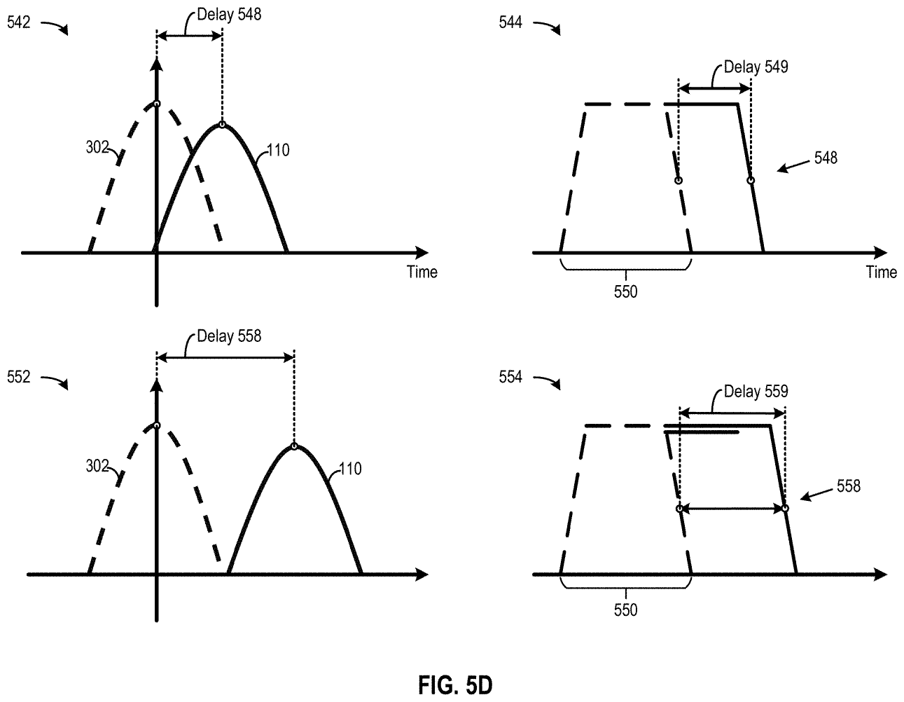

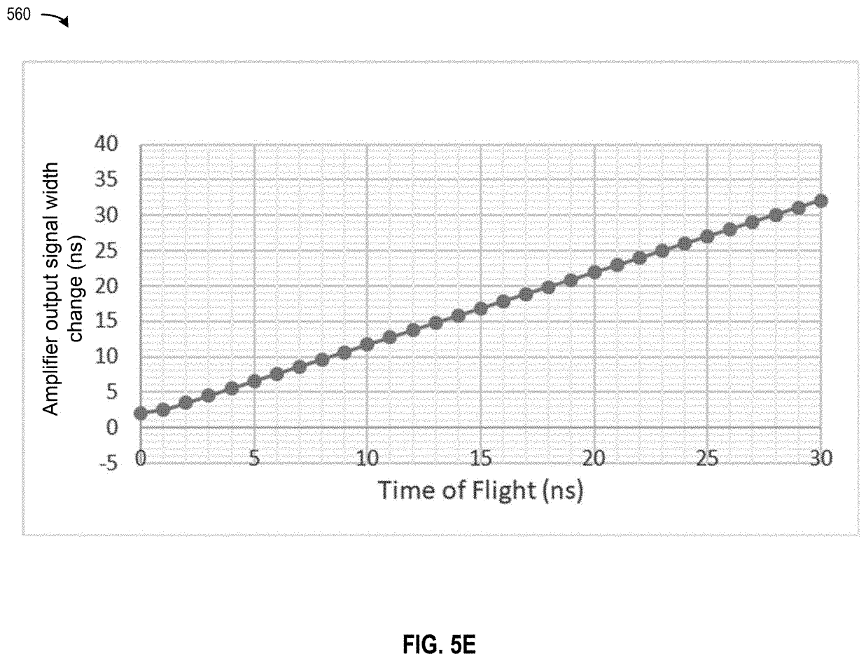

In some examples, referring to FIG. 5A to FIG. 5E, the width of the pre-processed second light signal may vary with the signal level of the reflected first light signal, which can affect the accuracy of time-of-flight determination based on the width of the pre-processed second light signal. Specifically, in a case where the reflected first light signal saturates the pre-processing circuit, the width of the pre-processed second light signal can be dominated by the slow rate of charging/discharging of a parasitic capacitor at the pre-processing circuit, as well as the signal level of the output of the receiver based on the reflected first light signal. The signal level of the reflected first light signal may vary based on factors other than the time-of-flight including, for example, the reflectivity of the object. As the width of the pre-processed second light signal may vary due to factors other than the time-of-flight, error may be introduced if the time-of-flight of the first light signal is determined based on measuring the width of the pre-processed second light signal.

Referring to FIG. 5D, to improve the accuracy of the time-of-flight determination operation, the controller can determine the time-of-flight of the first light signal based on measuring a change in the width of the pre-processed second light signal. The change in the width of the pre-processed second light signal can represent the time difference between two separate charging/discharging events, attributed to the scatter signal and the reflected first light signal, at the parasitic capacitor of the pre-charging circuits, and the time difference is largely independent from the signal level of the reflected first light signal. The controller can compare the width of the pre-processed second light signal with a threshold width, such as the width of the pre-processed scatter signal, to measure the change in the width of the pre-processed second light signal. The controller can also maintain a mapping between different changes in the width of the pre-processed second light signal and different time-of-flights, based on FIG. 5E, which can be determined by simulation and/or a calibration operation at the LiDAR module. The controller can then refer to the mapping to determine the time-of-flight of the first light signal for a particular change in the width of the pre-processed second light signal.

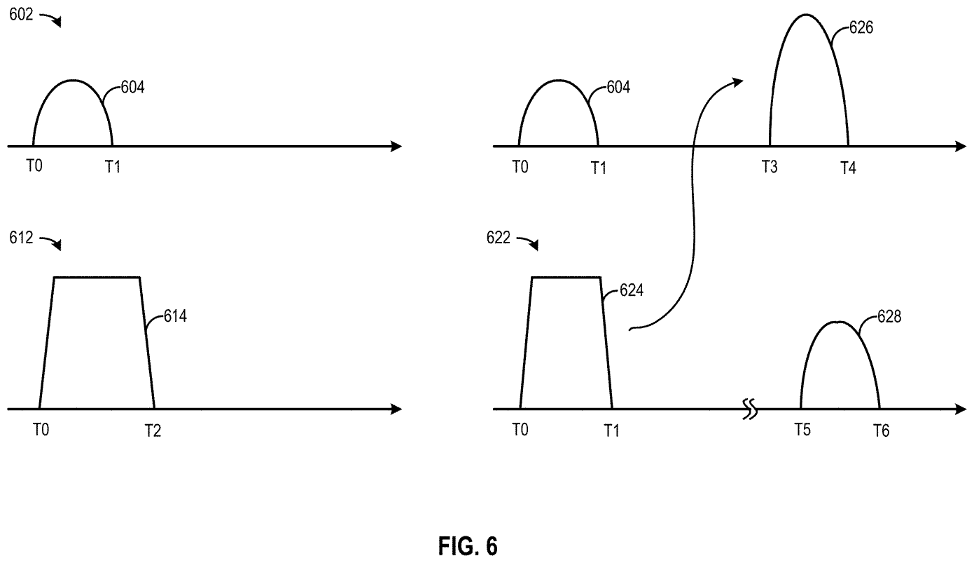

The techniques described in FIG. 4A to FIG. 5E can be used in a multiple-signal transmission scheme. Specifically, referring to FIG. 6, to perform an object detection and ranging operation, the controller can control the transmitter to first transmit the first light signal, which can be at a relatively low signal level. The low signal level of the first light signal can be designed to, for example, eye safety of nearby pedestrians who may be illuminated by the first light signal, and for detection and ranging over a shorter distance. The controller can then detect the second light signal using the receiver. The techniques described above can be used for detection and ranging of a nearby object based on the width of the second light signal. If the receiver receives a second light signal having the same width as the scatter signal, the controller can control the transmitter to transmit a third light signal having a larger signal level than the first light signal to perform the detection and ranging operation over a longer distance.

With the disclosed examples, a close proximity object detection and ranging operation can be performed based on measuring the width of the pre-processed output of the reflected signal. Such arrangements can improve the accuracy of time-of-flight determination in the presence of other non-idealities, such as the coupling of transmitted signals into the receiver circuit, the saturation of pre-processing circuit by the received signals from a nearby object and/or by a highly-reflective object. This allows the ranging operating to be performed over a wider range of measurement distances and levels of reflectivity. All of these can improve the robustness and performance of the object detection and ranging operation.

### Typical System Environment for Certain Examples

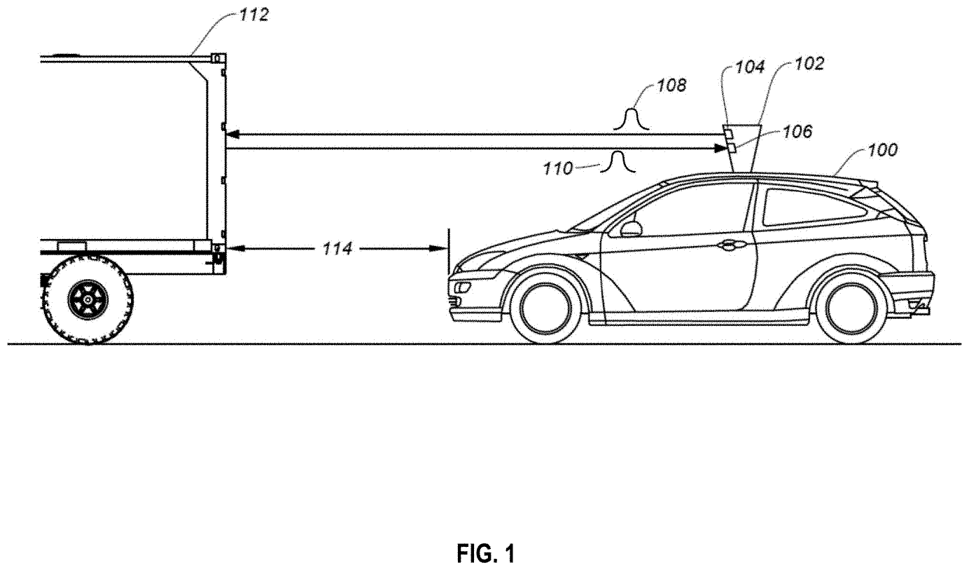

FIG. 1 illustrates an autonomous vehicle 100 in which the disclosed techniques can be implemented. Autonomous vehicle 100 includes a ranging system, such as LiDAR module 102. LiDAR module 102 allows autonomous vehicle 100 to perform object detection and ranging in a surrounding environment. Based on the result of object detection and ranging, autonomous vehicle 100 can maneuver to avoid a collision with the object. LiDAR module 102 can include a light steering transmitter 104 and a receiver 106. Light steering transmitter 104 can project one or more light signals 108 at various directions at different times in any suitable scanning pattern, while receiver 106 can monitor for a light signal 110 which is generated by the reflection of light signal 108 by an object. Light signals 108 and 110 may include, for example, a light pulse, a frequency modulated continuous wave (FMCW) signal, an amplitude modulated continuous wave (AMCW) signal, etc. LiDAR module 102 can detect the object based on the reception of light pulse 110, and can perform a ranging determination (e.g., measuring a distance of the object) based on a time difference between light signals 108 and 110. For example, as shown in FIG. 1, LiDAR module 102 can transmit light signal 108 at a direction directly in front of autonomous vehicle 100 at time T1 and receive light signal 110 reflected by an object 112 (e.g., another vehicle) at time T2. Based on the reception of light signal 110, LiDAR module 102 can determine that object 112 is directly in front of autonomous vehicle 100. Moreover, based on the time difference between T1 and T2, LiDAR module 102 can also determine a distance 114 between autonomous vehicle 100 and object 112. Autonomous vehicle 100 can adjust its speed (e.g., slowing or stopping) to avoid collision with object 112 based on the detection and ranging of object 112 by LiDAR module 102.

FIG. 2A illustrates examples of components of a LiDAR module 102. LiDAR module 102 includes a transmitter circuit 202, a receiver circuit 204, and a controller 206. Transmitter 202 may include a light source (e.g., a pulsed laser diode, a source of FMCW signal, a source of AMCW signal, etc.) to transmit light signal 108. Controller 206 includes a signal generator circuit 208, a processing circuit 210, and a distance determination circuit 212. Signal generator circuit 208 can determine the amplitude characteristics of light signal 108, as well as the time when transmitter circuit 202 transmits light signal 108.

Graphs 220 and 222 illustrate examples of light signal 108 and reflected light signal 110. Referring to graph 220 of FIG. 2A, which shows the output of transmitter 202 with respect to time, signal generator 208 can control transmitter 202 to transmit light signal 108 between times T0 and T2, with light signal 108 peaking at time T1. Light signal 108 can be reflected off object 209 to become reflected light signal 110. Referring to graph 222 of FIG. 2A, which shows the input signals at receiver circuit 204 with respect to time, receiver circuit 204 can detect the reflected light signal 110 together with other light signals (e.g., signal 213).

Processing circuit 210 can process the outputs of receiver circuit 204 to extract reflected light signal 110. Specifically, processing circuit 210 may include a digital signal processor (DSP) to perform the signal processing operations on the received signals. The signal processing operations may include, for example, determining a pattern of changes of the signal level with respect to time, such as an amplitude envelop shape or other amplitude characteristics, of the receive signals. As another example, the processing may include Fast Fourier Transform (FFT) to extract frequency contents of the received signals.

In addition, distance determination module 212 can collect the amplitude characteristics and/or frequency contents information of transmitted light signal 108 and received signals from, respectively, signal generator 208 and processing engine 210, and perform a search for reflected light signal 110 in the received signals. The search can be based on, for example, identifying a signal having amplitude characteristics and/or frequency contents that are scaled copies of amplitude characteristics and/or frequency contents of transmitted light signal 108. Referring to graph 222, based on amplitude characteristics, distance determination module 212 may determine that the received signal 213 between times T3 and T4 is not reflected light signal 110 because it does not have the same amplitude envelop shape as transmitted light pulse 108. Distance determination module 212 may also identify the received signals between times T5 and T7 as reflected light signal 110 based on the received signals having the same amplitude envelop shape as transmitted light signal 108. Distance determination module 212 can determine a time difference between transmitted light signal 108 and reflected light signal 110 to represent time-of-flight (TOF) 224 of light signal 108 between LiDAR module 102 and object 209. The time difference can be measured between, for example, time T1 when light signal 108 peaks and time T6 when reflected light signal 110 peaks. Based on time-of-flight 224 and speed of propagation of light signals, distance determination module 212 can determine a distance 226 between LiDAR module 102 and object 209.

FIG. 2B illustrates example internal components of receiver circuit 204. As shown in FIG. 2B, receiver circuit 204 can include a photodetector 230. Photodetector 230 can receive light and convert the photons of the received light (e.g., signals 110 and 213) into an electrical current. Photodetector 230 can include, for example, an avalanche photodiode (APD), a single-photon avalanche diode (SPAD), a silicon photomultiplier (SiPM), etc. The following equation provides an example relationship between a peak photodetector current at receiver circuit 204, which represents the reflected light signal level at the input of the receiver circuit, and the measurement distance and the object reflectivity:

$${I}_{peak} ∝ \frac{Reflectivity}{{Distance}^{2}} \times {e}^{- 2 γ \times Distance} \qquad ( Equation 1 )$$

In Equation 1, the peak photodetector current Iₚₑₐₖ can be directly proportional to the reflectivity for a given measurement distance. Moreover, Iₚₑₐₖ is related to a reciprocal of square of the measurement distance as well as a negative exponential function of the measurement distance, which means Iₚₑₐₖ drops at a very high rate with respect to the measurement distance. Gamma (γ) can refer to the light absorption coefficient of the atmosphere.

FIG. 2C illustrates examples of distributions of peak photodetector current Iₚₑₐₖ with respect to measurement distance and reflectivity of an object. Graph 252 represents an example distribution of normalized peak photodetector current Iₚₑₐₖ for an object of reflectivity of 0.8 across a range of measurement distances of 0-200 m (meters), whereas graph 254 represents an example distribution of normalized peak photodetector current Iₚₑₐₖ for an object of reflectivity of 0.1 across the same range of measurement distances of 0-200 m. As shown in FIG. 2C, across a range of measurement distances (0-200 m) and a range of reflectivity (0.1 to 0.8), the normalized peak photodetector current Iₚₑₐₖ can have a range from 1 to 10⁷, and therefore the peak photodetector current Iₚₑₐₖ can vary by a factor of 10⁷.

Referring back to FIG. 2B, receiver circuit 204 further includes an amplifier 232 and a digitizer 234. Amplifier 232 and digitizer 234 can be part of a pre-processing circuit to pre-process the output of photodetector 230. The pre-processing operations can be performed to facilitate the signal processing operations at processing circuit 210 of controller 206. For example, amplifier 232 can convert the current output by photodetector 230 to a voltage, and amplify the voltage, or it can filter or apply equalization on the current output to shape the signal or filter the noise. In some examples, receiver circuit may also include components to perform filtering and/or equalization in addition to amplifier 232. Digitizer 234 can generate digital outputs based on the amplified voltage. For example, digitizer 234 can include a time-to-digital converter (TDC) 236 to generate timestamp outputs 240 representing, for example, the times when the signals are received (e.g., times T3, T4, T5, and T7). Moreover, digitizer 234 can also include an analog-to-digital converter (ADC) to generate digitized voltage outputs 242, which can include a sequence of digital values representing the voltages output by amplifier 232 corresponding to the outputs of photodetector 230. The digital signal processor (DSP) of processing circuit 210 can then perform the signal processing operations on the digital outputs of digitizer 234.

The pre-processing circuit of receiver circuit 204, such as amplifier 232 and digitizer 234, typically have a dynamic range for which the output is linearly related to the input. The linearity of the pre-processing circuit is critical to preserving the amplitude envelop shape/characteristics and frequency contents of the received signals (e.g., signals 110 and 213) in the pre-processed output, to enable processing circuit 210 to extract those information from the pre-processed output. The lower end of the dynamic range can be related to, for example, the noise floor of the pre-processing circuit. If the input signal level is below the lower end of the dynamic range, the pre-processing circuit may be unable to distinguish the input from noise. The upper end of the input range can be related to, for example, a signal level which causes the amplifier and/or the ADC to saturate. If the input signal level is above the upper end of the dynamic range, the output of the pre-processing circuit may stay at the saturation level and is no longer linearly related to the input. Referring back to FIG. 2C, amplifier 232 and digitizer 234 may be designed to be linear over the entire range of normalized peak photodetector current Iₚₑₐₖ, from 1 to 10⁷. The problem of saturation can become worsened if the amplification gain of the amplifier 232 is increased to increase the lower end of the dynamic range, which enables detection of weak reflected signals from afar, to increase the maximum distance or reduce the minimum object reflectivity supported by the object detection and ranging operation. With an increased amplification gain, as the signal level of the output increases for the same input signal level, it becomes easier for the amplifier to become saturated by the input.

The detection and ranging operation for a nearby object that is in a close proximity to the observer (e.g., an object within one meter from the observer) can be especially susceptible to saturation. This is because reflected signals from a nearby object typically experience very little attenuation and can have a very high signal level when reaching the input of the receiver. The signal level of the reflected signals may be higher than the upper limit of the dynamic range of amplifier 232 and/or digitizer 234, and may saturate amplifier 232 and/or digitizer 234 as a result.

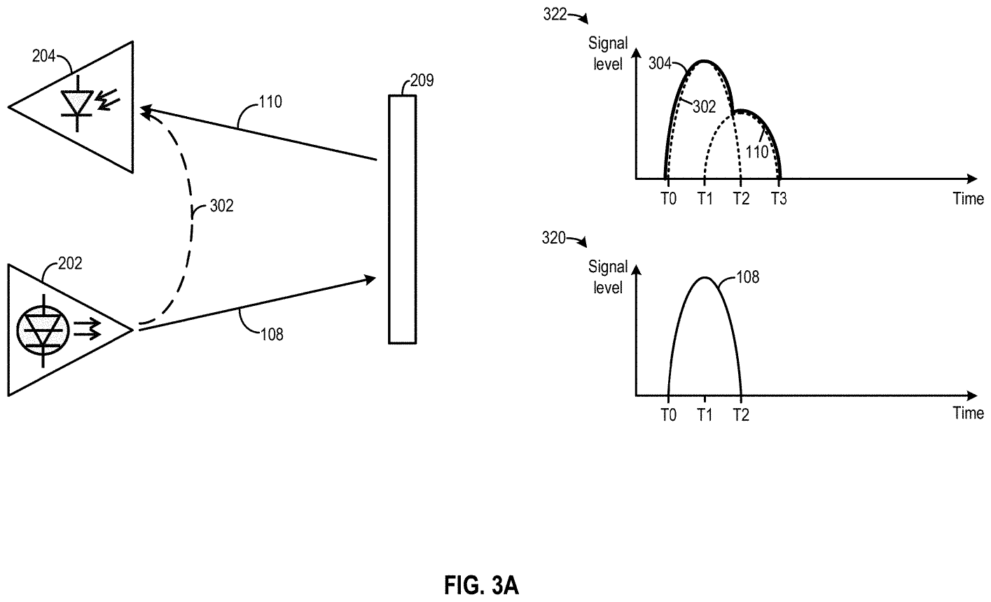

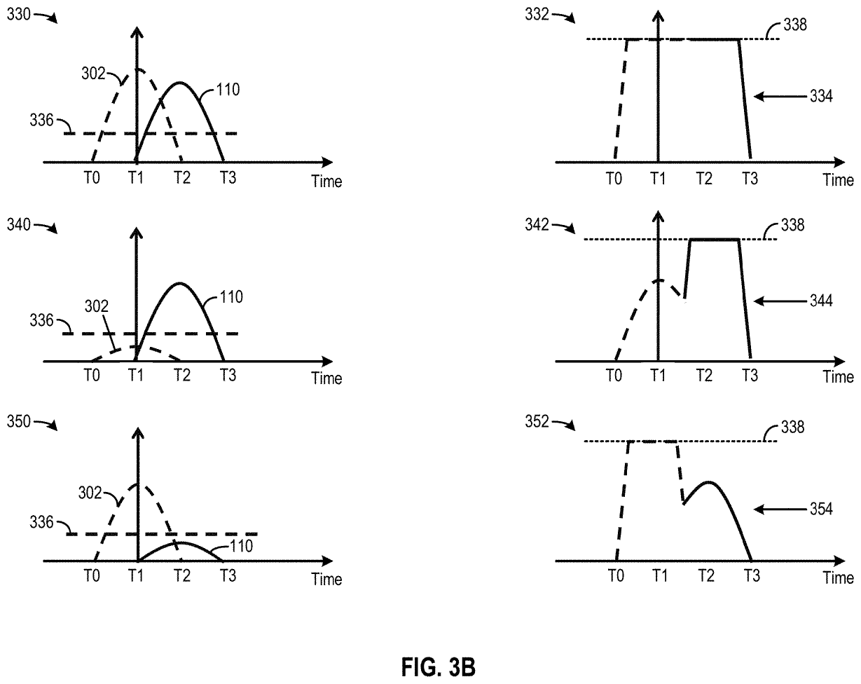

In addition to saturation, other challenges exist for the detection and ranging operation of close proximity objects, such as coupling of transmit signals from transmitter circuit 202 into receiver circuit 204. The coupling can be due to, for example, scattering by the optical components, the chassis, etc., of LiDAR module 102. The coupled signal can become a scatter signal at the input of receiver circuit 204. FIG. 3A-FIG. 3C illustrate example effects of scatter signal on the detection and ranging operation. As shown in the left of FIG. 3A, through the aforementioned effect of scattering, light signal 108 can be coupled into the input of receiver circuit 204 as a scatter signal 302. Referring to graphs 320 and 322 in the right of FIG. 3A, scatter signal 302 can appear at the input of receiver circuit 204 at substantially the same time as the transmission of light signal 108 by transmitter circuit 202 (e.g., between times T0 and T2). In addition, if object 209 is in close proximity to LiDAR module 102, reflected signal 110 can also appear at the input of receiver circuit 204 soon after the transmission of light signal 108 by transmitter circuit 202, for example between times T1 and T3. As a result, as shown in graph 322, reflected signal 110 and scatter signal 302 can at least partially overlap with each other to form a received light signal 304. As received light signal 304 does not have the same amplitude characteristics nor frequency contents as the transmitted light signal 108, distance determination module 212 may be unable to pair received light signal 304 with the transmitted light signal 108, and determine the time-of-flight of light signal 108 based on the time difference between light signal 108 and other signals.

In addition, as described above, reflected signal 110 from a nearby object typically have a very high signal level when reaching the input of receiver circuit 204, and may saturate receiver circuit 204. The saturation of receiver circuit 204 by reflected signal 110, as well as the overlap between reflected light signal 110 and scatter signal 302, can create an output at amplifier 232 which, even if paired with transmitted light signal 108, can introduce ambiguity in the time-of-flight determination. FIG. 3B illustrates examples of reflected signal 110 and scatter signal 302 of different signal levels, and the corresponding outputs of amplifier 232. Graphs 330 and 332 illustrate an example of reflected signal 110 and scatter signal 302 and the corresponding output 334 of amplifier 232. As shown in graph 330, both scatter signal 302 and reflected light signal 110 exceed a saturation limit 336 of amplifier 232. As a result, output 334 of amplifier 232 reaches the maximum signal level 338 soon after time T0 and can stay there till time T3. As output 334 of amplifier 232 lacks the peak of reflected signal 110, distance determination circuit 212 may be unable to determine the actual time difference between reflected light signal 110 and transmitted light signal 108 based on output 334.

Graphs 340 and 342 illustrate another example of reflected signal 110 and scatter signal 302 and the corresponding output 344 of amplifier 232. As shown in graph 340, scatter signal 302 is below saturation limit 336, therefore the portion of output 344 of amplifier 232 corresponding to scatter signal 302 (e.g., between times T0 and T2) can be linearly related to scatter signal 302. Moreover, reflected signal 110 exceeds saturation limit 336. As a result, the portion of output 344 of amplifier 232 corresponding to reflected signal 110 (e.g., between times T2 and T3) reaches the maximum signal level 338. As output 344 includes multiple peaks (e.g., at times T1 and T2), distance determination circuit 212 may be unable to determine the actual time difference between reflected light signal 110 and transmitted light signal 108 based on output 344.

Graphs 350 and 352 illustrate another example of reflected signal 110 and scatter signal 302 and the corresponding output 354 of amplifier 232. As shown in graph 350, scatter signal 302 is above saturation limit 336, while reflected signal 110 is below saturation limit 336 (e.g., due to low reflectivity of object 209). As a result, the portion of output 354 of amplifier 232 corresponding to scatter signal 302 (e.g., between times T0 and T2) reaches the maximum signal level 338, whereas the portion of output 352 of amplifier 232 corresponding to reflected signal 110 (e.g., between times T2 and T3) can be linearly related to reflected signal 110. As output 354 also includes multiple peaks (e.g., at times T1 and T2), distance determination circuit 212 may be unable to determine the actual time difference between reflected light signal 110 and transmitted light signal 108 based on output 344.

### Example Techniques to Improve Detection and Ranging Operation

FIG. 4A-FIG. 4D illustrate example techniques of performing detection and ranging operations that can address at least some of the issues above. In FIG. 4A, instead of (or in addition to) measuring a time difference between a received signal (e.g., light signal 304) and a transmitted signal (e.g., light signal 108) to determine the time-of-flight of the transmitted signal, controller 206 can determine the time-of-flight based on measuring a width 402 of the received signal.

Specifically, as described above, scatter signal 302 is caused by the coupling of transmitted light signal 108 from transmitter circuit 202 into receiver circuit 204, therefore, scatter signal 302 is received at around the same time when transmitter circuit 202 transmits light signal 108. Moreover, reflected light signal 110 arrives at receiver circuit 204 soon after scatter signal 302 due to the close proximity of the object that reflects the light signal. As a result, a part of scatter signal 302 can overlap with a part of reflected light signal 110 to become light signal 304. Leading edge 404 of light signal 304 can correspond to the leading edge of scatter signal 302/transmitted light signal 108, whereas trailing edge 406 of light signal 304 can correspond to the trailing edge of reflected light signal 110. Since the time difference between leading edge 404 and trailing edge 406 is related to a delay 408 between transmitted light signal 108/scatter signal 302 and reflected light signal 110, the time-of-flight of light signal 108, which corresponds to delay 408, can be derived from width 402 of light signal 304 between leading edge 404 and trailing edge 406.

Controller 206 can determine the time-of-flight of light signal 108 based on measuring the width of light signal 304 at the output of photodetector 230, or based on measuring the width the amplified light signal 304 at the output of amplifier 232. The width can be measured by, for example, TDC 236 of digitizer 234, a DSP of processing circuit 210, etc. For example, referring to graphs 330, 340, and 350 of FIG. 4B, TDC 236 can measure a first time when the leading edge of light signal 304 (corresponding to the leading edge of scatter signal 302) crosses a threshold 410. TDC 236 can also measure a second time when the trailing edge of light signal 304 (corresponding to the trailing edge of reflected signal 110) crosses threshold 410. As another example, referring to graphs 332, 342, and 352 of FIG. 4B, TDC 236 can also measure a first time when the leading edge of amplifier outputs 334, 344, and 354 (corresponding to the leading edge of scatter signal 302) crosses a threshold 420. TDC 236 can also measure a second time when the trailing edge of the amplifier output (corresponding to the trailing edge of reflected signal 110) crosses threshold 420. Controller 206 can then measure width 402 of light signal 304 based on a difference between the first time and the second time. In some examples, the DSP may also apply some processing on amplified light signal 304, such as matched filtering, before computing width.

In graphs 330, 340, and 350, threshold 410 can be a current threshold for comparing with the photodetector current, whereas in graphs 332, 342, and 352, threshold 420 can be a voltage threshold for comparing with the amplifier output. Thresholds 410 and 420 can be set based on, for example, the minimum signal level of the photodetector current or of the amplifier output for a particular operating condition. For example, referring back to FIG. 2C, thresholds 410 and 420 can be set based on the minimum photodetector current (and the corresponding amplifier output) to be detected for reflected signal 110 from the maximum distance where reflected signal 110 and scatter signal 302 overlaps to form light signal 304, and from an object of the minimum reflectivity to be detected (0.1), to ensure that the leading and trailing edges of the photodetector/amplifier output crosses the threshold, and the timestamps for the crossing can be measured by TDC 236.

After measuring the width of light signal 304 (or its amplifier output signal), controller 206 can first determine whether the light signal includes both the scatter signal and a reflected light signal. The determination can be based on, for example, measuring the width of the light signal against a width of the scatter signal. If the light signal includes both the scatter signal and the reflected light signal, the controller can determine the time-of-flight information from the measured width based on various techniques. In one example, referring to FIG. 4C, controller 206 can maintain a mapping table 430 between different widths of the received light signal 304 (measured at the outputs of photodetector 230 and/or amplifier 232) and different time-of-flights. The mapping table can be determined by simulation, and/or by a calibration operation at LiDAR module 102. For example, as part of the calibration operation, LiDAR module 102 can receive different light signals 304 (a combination of scatter signal 302 and reflected light signal 110) from different pre-determined distances, and the widths of the different light signals 304 can be recorded and mapped to the distances or the corresponding time-of-flights. Controller 206 can then refer to mapping table 430 to determine the time-of-flight of the transmitted light signal 108 for a particular width of the received light signal 304. In some examples, multiple mapping tables 430 can be provided for different operation conditions, such as temperatures, and controller 206 can select a mapping table to determine time-of-flight based on the operation condition.

Controller 206 can determine the time-of-flight of light signal 108 based on measuring the width of light signal 304, if it determines that the received light signal includes both scatter signal 302 and reflected light signal 110. On the other hand, if the width of light signal 304 indicates that it does not include reflected light signal 110, controller 206 can determine that no object is detected. Further, if reflected light signal 110 comes from a faraway object, reflected light signal 110 may arrive at receiver circuit 204 a relatively long time after scatter signal 302. For example, referring to graph 440 of FIG. 4D, reflected light signal 110 may arrive between times T8 and T9, long after times T0 to T2 when scatter signal 302 is received. As a result, as shown in graph 450 of FIG. 4D, amplifier 232 can output two separate signals 442 and 444 corresponding to scatter signal 302 and reflected light signal 110. In graphs 440 and 450, as both reflected light signal 110 and scatter signal 302 are above saturation limit 336 of amplifier 232, both output signals 442 and 444 can reach the maximum signal level 338. In such a case, controller 206 can then determine the time-of-flight of light signal 108 based on a time difference between output signals 442 and 444. The time difference can be determined based on, for example, a time difference between a pair of corresponding edges (e.g., a pair of leading edges 452 and 454, a pair of trailing edges 456 and 458, etc.) of output signals 442 and 444, a time difference between corresponding points (e.g., peaks if not saturated, middle points, etc.) of output signals 442 and 444, etc., based on the outputs of TDC 236 and/or ADC 238. For example, TDC 236 can capture a first time when leading edge 452 of output signal 442 crosses a threshold 460, and a second time when leading edge 454 crosses threshold 460, and determine the time difference between the first time and the second time.

Controller 206 can determine whether the received light signal includes reflected light signal 110 and scatter signal 302 using various techniques. In one example, the controller can compare the width of the amplifier output for the received light signal with a threshold width. The threshold width can represent the width of the amplifier output for, for example, a standalone reflected light signal 110, a standalone scatter signal 302, etc. If the width of the amplifier output for the received light signal exceeds the threshold width, the controller can determine that the received light signal includes not both the reflected first light signal and the scatter signal, and the width of the amplifier output for the received light signal can be used to determine the time-of-flight. In the example of FIG. 4D, the controller can determine that the width of each of output signals 442 and 444, based on the time difference between the leading edge and the trailing edge of each output signal, is below the threshold width. The controller can then determine that each of output signals 442 and 444 represents a standalone reflected light signal 110 or a standalone scatter signal 302.

In FIG. 4A-FIG. 4D, the thresholds 410, 420, and 460 can be fixed, or can vary over time. For example, the threshold can start a high level at the beginning of a receive time window for detecting a nearby object from which the reflected light signal's intensity is the highest. The threshold can decrease with time for detecting faraway objects from which the reflected light signal's intensity is reduced due to attenuation. The mapping between the widths of the received light signal and different time-of-flights in mapping table 430 can reflect the different thresholds. For example, in mapping table 430, a longer time-of-flight can be obtained from comparing the reflected light signal with a lower-level threshold, whereas a shorter time-of-flight can be obtained from comparing the reflected light signal with a higher-level threshold.

FIG. 5A to FIG. 5F illustrate other example techniques of performing detection and ranging operations based on the width of received light signals. Referring to FIG. 5A, the width of the amplifier output for the received light signal may vary with the signal level of the received light signal, which can affect the accuracy of time-of-flight determination based on the width of the amplifier output signal. For example, as shown in graphs 502 and 504, if the reflected light signal 110, having a width wᵢₙ, exceeds saturation limit 336, the corresponding output signal 506 of amplifier 232 can have a width wont larger than width wᵢₙ. On the other hand, as shown in graphs 512 and 514, if the reflected light signal 110 is below saturation limit 336, the corresponding output signal 516 can have the same width wᵢₙ as the reflected light signal 110.

As the width of the amplifier output signal may vary due to factors other than the time-of-flight, error may be introduced if the time-of-flight of the first light signal is determined based on measuring the width of amplifier output signal, as described above in FIG. 4A-FIG. 4D. Specifically, in both graphs 504 and 514 of FIG. 5A, the reflected light signal 110 can come through the same distance to reach receiver circuit 204, therefore both output signals 506 and 516 arrive at receiver circuit 204 at the same time T8. The difference in the signal levels of reflected light signal 110 can be due to, for example, a difference in the reflectivity of the objects that reflect the light signals, even though the objects are separated from receiver circuit 204 by the same distance. Therefore, error may arise if controller 206 determines, based on the different widths of amplifier output signals, that the objects are separated from receiver circuit 204 by different distances.

FIG. 5B illustrates a graph 520 that illustrates an example relationship between the amplifier output signal width and photodetector current. The photodetector current can be linearly related to the signal level of the received light signal. As shown in graph 520, the amplifier output signal width can remain constant until the photodetector current reaches a threshold value 522, which can correspond to the saturation limit of amplifier 232. As the photodetector current increases beyond threshold value 522, the amplifier output signal width increases.

The variations in the amplifier output signal width can be due to the charging of parasitic capacitors by amplifier 232 when amplifier 232 is in a saturated state. FIG. 5C illustrates an example circuit model of part of receiver circuit 204 as well as changes of internal voltages of receiver circuit 204 in response to a photodetector current pulse. As shown on the left of FIG. 5C, receiver circuit 204 may include parasitic capacitance 530 at the input of amplifier 232. The parasitic capacitance may be contributed by, for example, interconnect capacitance between photodetector 230 and amplifier 232. In addition, amplifier 232 can also include a feedback network 532, which can include a network of resistor and capacitor, coupled across the input and output of amplifier 232.

The right of FIG. 5C includes a chart 540, which includes a graph 542, a graph 544, and a graph 546. Graph 542 describes the variation of photodetector current output by photodetector 230 with respect to time. Graph 544 describes the variation of input voltage of amplifier 232, whereas graph 546 describes the variation of output voltage of amplifier 232. As shown in graph 542, at about 15 nanoseconds (ns), photodetector 230 receives a reflected light signal, which causes photodetector 230 to generate a current pulse of −1.8 mA. The amplitude of the current pulse can be above the threshold value 522 of FIG. 5B. The current pulse can discharge parasitic capacitance 530 and set an initial input voltage of −0.6 v at 15 ns. As a result of the negative input voltage, the output voltage of amplifier 232 is saturated and outputs a maximum voltage of 1.7 v.

Referring to graphs 542, 544, and 546, after 15 ns, the current pulse ends and photodetector 230 no longer outputs current. Amplifier 232 can charge the parasitic capacitance 530 via feedback network 532 to raise the input voltage until the input voltage reaches at around 0.5 v at 55 ns, at which point the output of amplifier 232 switches back from 1.7 v to zero. As amplifier 232 is in the saturated state, the current output by amplifier 232 is a constant, and the total time for amplifier 232 to charge up the input node increases as the amplitude of the current pulse increases. On the other hand, if amplifier 232 is in a linear state when the amplitude of the current pulse is below threshold value 522, the amplifier 232, along with its feedback network 532 ensures that the input node voltage holds steady. The amplifier output voltage follows input pulse and hence the output pulse width follows input current and stays fixed, as shown in FIG. 5B.

To account for the variations in the amplifier output signal width with the signal level of the received light signal, controller 206 can determine the time-of-flight of transmitted light signal 108 based on measuring a degree of change in the width of the amplifier output signal. Specifically, the change in the width of the amplifier output signal can represent the time difference between two separate charging/discharging events, attributed to scatter signal 302 and reflected light signal 110, at the parasitic capacitor of amplifier circuit 232. The time difference, as well as the degree of change in the width of the amplifier output signal, can reflect the time-of-flight and can be largely independent from the signal level of the reflected first light signal. Controller 206 can compare the width of the amplifier output signal with a threshold signal width, such as the width of the amplifier output for scatter signal 302, to measure a degree of change in the width of the amplifier output signal.

FIG. 5D illustrate examples of time-of-flight determination based on changes in the amplifier output signal width. Graph 542 shows an example of scatter signal 302 and reflected light signal 110, whereas graph 544 shows the corresponding amplifier output 548. In graph 542, the peaks of scatter signal 302 and reflected light signal 110 are separated by a delay 548. In graph 544, the width of amplifier output 548 is also extended from output 550 of standalone scatter signal. The extension is due to the separate charging/discharging event caused by reflected light signal 110. As a result, the width of amplifier output 548 extends by approximately delay 549.

In addition, graph 552 shows another example of scatter signal 302 and reflected light signal 110, whereas graph 554 shows the corresponding amplifier output 558. In graph 552, the peaks of scatter signal 302 and reflected light signal 110 are separated by a delay 558. In graph 554, the width of amplifier output 558 is also extended from output 550 of standalone scatter signal. The extension is due to the separate charging/discharging event caused by reflected light signal 110. As a result, the width of amplifier output 558 extends by approximately delay 559.

FIG. 5E illustrates a graph 560 that illustrates the degrees of change in the width of the amplifier output signal with respect to time-of-flight. The change can be determined based on comparing the width of the amplifier output signal against a threshold signal width, such as the width of the amplifier output for scatter signal 302. As shown in FIG. 5E, the degree of change can be linearly related to the time-of-flight. Controller 206 can maintain a mapping table that lists the different degrees of change in the amplifier output signal width and the corresponding time-of-flight, which can be determined from a simulation and/or a calibration operation at the LiDAR module. The controller can then refer to the mapping table to determine the time-of-flight for a particular degree of change in the width of the amplifier output signal.

The techniques described in FIG. 4A to FIG. 5E can be used in a multiple-signal transmit signal scheme. FIG. 6 illustrates an example of the multiple-signal transmit signal scheme to perform an object detection and ranging operation. Specifically, as shown in graph 602, between times T0 and T1 controller 206 can control transmitter circuit 202 to transmit a first light signal 604. First light signal 604 can be at a relatively low signal level. The low signal level of the first light signal can be designed to, for example, for eye safety of nearby pedestrians who may be illuminated by first light signal 604, and for detection and ranging over a shorter distance. In graph 612, if controller may detect an amplifier output 614 between times T0 and T2, and perform a ranging operation to determine the distance between the object and LiDAR module 102 based on amplifier output 614. The detection and ranging operation can be performed based on the techniques described in FIG. 4A to FIG. 5E. For example, to distinguish between first light signal 604 and scatter signal 302, controller 206 can measure the width of amplifier output 614 and compare that with a threshold width of the amplifier output for scatter signal 302. If the width of amplifier output 614 exceeds the threshold width, controller 206 can determine that amplifier output 614 includes a reflected light signal from a nearby object, and determine the distance based on the width of amplifier output 614 as described above in FIG. 4A to FIG. 5E.

On the other hand, referring to graph 622, controller 206 may detect an amplifier output 624 between times T0 and T1 having the same width as the threshold width, which indicate that the received light signal includes scatter signal 302 but not the reflected light signal. Controller 206 can then control transmitter circuit 202 to transmit another light signal 626 between times T3 and T4. Light signal 626 can have a higher signal level than light signal 604 for detection and ranging over a longer distance. Controller 206 can detect an amplifier output 628 between times T5 and T6, and measure a distance based on, for example, a time difference between amplifier outputs 624 and 628.

### Method

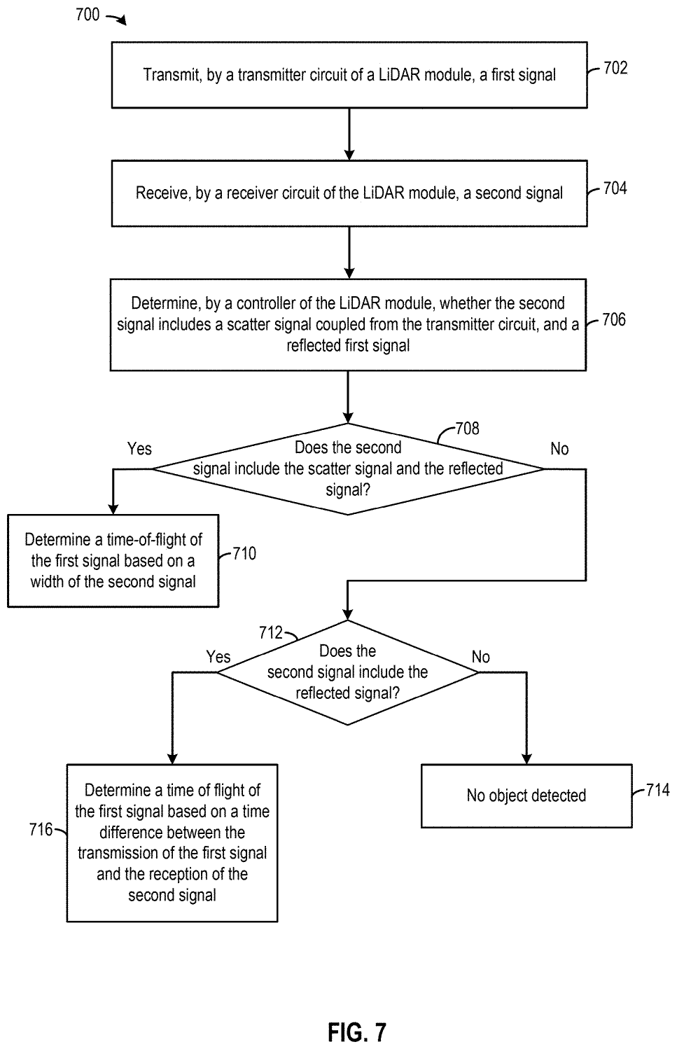

FIG. 7 illustrates a flowchart of example process 700 for performing a ranging operation. Process 700 can be performed by, for example, LiDAR module 102 which can include a transmitter circuit (e.g., transmitter 202), a receiver circuit (e.g., receiver 204), pre-processing circuit including an amplifier and a digitizer (e.g., amplifier 232 and digitizer 234), and a controller (e.g., controller 206).

Process 700 begins with operation 702, in which the transmitter circuit transmits a first light signal. The first light signal is a light signal transmitted by a light source of the transmitter circuit. The light source may include, for example, a pulsed laser diode, a source of FMCW signal, a source of AMCW signal, etc.

In operation 704, the receiver circuit receives a second light signal. The second light signal may include a scatter signal, as well as a reflected first light signal from another object.

Specifically, referring to FIG. 4A, the scatter signal can be caused by the coupling of the first light signal from the transmitter circuit into the receiver circuit. Therefore, the receiver may receive the scatter signal at around the same time when the transmitter transmits the first light signal. If the first light signal is reflected from a nearby object, the reflected first light signal may arrive at the receiver soon after the scatter signal (and the transmission of the first light signal), and a part of the scatter signal can overlap with at least part of reflected first light signal to become the second light signal. The leading edge of the second light signal can correspond to the leading edge of the scatter signal/first light signal, whereas the trailing edge of the second light signal can correspond to the trailing edge of the reflected first light signal. As the time difference between the leading edge of the second light signal and the trailing edge of the second light signal is related to the delay between the scatter signal/first light signal and the reflected first light signal, the time-of-flight of the first light signal can also be derived from the width of the second light signal.

On the other hand, as shown in FIG. 4D, if the first light signal is reflected from a faraway object, the reflected first light signal may arrive at the receiver circuit at a relatively long time after the scatter signal. In such a case, the receiver may receive the reflected first light signal as the second light signal which does not include the scatter signal.

In operation 706, the controller determines whether the second light signal includes a scatter signal and the reflected first light signal. The controller can determine whether the second light signal includes the reflected first light signal and the scatter signal based on, for example, comparing the width of the second light signal with a threshold width. The threshold width can represent the width of a standalone pre-processed reflected first light signal, the width of a standalone pre-processed scatter signal, etc. If the width of the second light signal exceeds the threshold width, the controller can determine that the second light signal includes not only the reflected first light signal but also the scatter signal.

If the controller determines that the second light signal includes the scatter signal and the reflected signal (in operation 708), the controller can determine a time-of-flight of the first light signal based on the width of the second light signal, in operation 710. For example, referring to FIG. 4B, the pre-processing circuit, such as a time-to-digital converter (TDC), can measure a first time when the leading edge of the second light signal (or the amplified second light signal) crosses a threshold, and a second time when the trailing edge of the second light signal (or the amplified second light signal) crosses the threshold. The width of the second light signal can then be determined based on the difference between the first time and the second time. The threshold can be set based on, for example, the minimum signal level of the second light signal (or the amplified second light signal) to be detected for a particular operation condition, to ensure that the leading and trailing edges of second light signal, at the outputs of the photodetector and of the amplifier, cross the threshold. In one example, referring to FIG. 4C, the controller can maintain a mapping between different widths of the second light signal and different time-of-flights, which can be determined by simulation and/or a calibration operation at the LiDAR module. The controller can then refer to the mapping to determine the time-of-flight of the first light signal for a particular width of the second light signal.

In some examples, referring to FIG. 5D, to improve the accuracy of the time-of-flight determination operation, the controller can determine the time-of-flight of the first light signal based on measuring a change in the width of the pre-processed second light signal. The change in the width of the pre-processed second light signal can represent the time difference between two separate charging/discharging events, attributed to the scatter signal and the reflected first light signal, at the parasitic capacitor of the pre-charging circuits, and the time difference is largely independent from the signal level of the reflected first light signal. The controller can compare the width of the second light signal with a threshold width, such as the width of the scatter signal, to measure the change in the width of the second light signal. The controller can also maintain a mapping between different changes in the width of the second light signal and different time-of-flights, based on FIG. 5E, which can be determined by simulation and/or a calibration operation at the LiDAR module. The controller can then refer to the mapping to determine the time-of-flight of the first light signal for a particular change in the width of the second light signal.

On the other hand, if the controller determines that the second light signal does not include both the scatter signal and the reflected first light signal (in operation 708), the controller can proceed to determine whether the second light signal includes the reflected first light signal, in operation 712. The determination can also be based on the width of the second light signal. If the width of the second light signal indicates that it does not include the reflected first light signal (in operation 712), the controller can determine that no object is detected, in operation 714.

Further, if the controller determines that the second light signal does not include the scatter signal but includes the reflected first light signal (in operation 712), which can also be based on the width of the second light signal, the controller can determine a time-of-flight of the first light signal based on a time difference between the transmission of the first light signal and the reception of the second light signal, in operation 716. For example, referring to FIG. 4D, the time difference can be determined based on, for example, a time difference between a pair of corresponding edges (e.g., a pair of leading edges, a pair of trailing edges, etc.) of the scatter signal and the second light signal, a time difference between corresponding points (e.g., peaks, middle points, etc.) of the scatter signal and the second light signal, etc.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the embodiments, alternative embodiments, etc., and the concepts thereof may be applied to any other embodiments described and/or within the spirit and scope of the disclosure.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

What is claimed is:

1. An apparatus, the apparatus being part of a Light Detection and Ranging (LiDAR) module of a vehicle and comprising a transmitter circuit, a receiver circuit, and a controller;
wherein the receiver circuit comprises a photodetector configured to convert a light signal into a photocurrent signal; and
wherein the controller is configured to:
transmit, using the transmitter circuit, a first light signal;
receive, using the photodetector of the receiver circuit, a second light signal;
determine whether the second light signal includes a scatter signal coupled from the transmitter circuit, and a reflected first light signal; and
based on whether the second light signal includes the scatter signal and the reflected first light signal, determine a time-of-flight of the first light signal based on one of: a width of the second light signal, or a time difference between the transmission of the first light signal and the reception of the second light signal.

2. The apparatus of claim 1, wherein the receiver circuit comprises an amplifier configured to convert the photocurrent signal into a voltage signal; and
wherein the controller is configured to determine the width of the second light signal based on a width of the voltage signal or a width of the photocurrent signal.

3. The apparatus of claim 1, wherein the width of the second light signal is determined based on a threshold signal level; and
wherein the threshold signal level is based on a minimum signal level of the second light signal received from an object at a maximum distance for which the second light signal includes the scatter signal and the reflected first light signal.

4. The apparatus of claim 3, wherein the minimum signal level is determined based on a minimum reflectivity of the object to be detected.

5. The apparatus of claim 1, wherein the controller is configured to determine whether the second light signal includes the scatter signal and the reflected first light signal based on comparing the width of the second light signal with a threshold signal width of the scatter signal.

6. The apparatus of claim 1, wherein the controller maintains a first mapping (430) between different widths of the second light signal and different time-of-flights; and
wherein the controller is configured to determine the time-of-flight based on the first mapping.

7. The apparatus of claim 1, wherein the controller is configured to:
determine a first width of the second light signal;
determine a second width of the scatter signal;
determine a degree of width change of the second light signal based on a difference between the first width and the second width; and
determine the time-of-flight based on the degree of width change.

8. The apparatus of claim 7, wherein the controller maintains a second mapping that maps different degrees of width change of the second light signal to different time-of-flights; and
wherein the controller is configured to determine the time-of-flight based on the second mapping.

9. The apparatus of claim 1, wherein the controller is configured to:
receive a third light signal corresponding to the scatter signal; and
determine a time difference between the third light signal and the second light signal for the time difference between the transmission of the first light signal and the reception of the second light signal.

10. The apparatus of claim 9, wherein the controller is configured to:
determine a first time when a first edge of the third light signal crosses a threshold;
determine a second time when a second edge of the second light signal crosses the threshold; and
determine the time difference based on the first time and the second time.

11. The apparatus of claim 1, wherein the controller is configured to:
determine that the second light signal includes the scatter signal but not the reflected first light signal; and
based on determining that the second light signal includes the scatter signal but not the reflected first light signal, transmit, using the transmitter circuit, a third light signal;
wherein a signal level of the third light signal is higher than a signal level of the first light signal.

12. The apparatus of claim 11, wherein the signal level of the first light signal is based on an eye safety requirement.

13. The apparatus of claim 1, wherein the receiver circuit further includes a time-to-digital converter (TDC); and
wherein the width of the second light signal is determined based on outputs of the TDC.

14. The apparatus of claim 1, wherein the photodetector comprises at least one of: an avalanche photodiode (APD), a single-photon avalanche diode (SPAD), or a silicon photomultiplier (SiPM).

15. A method comprising:
transmitting, by a transmitter circuit of a Light Detection and Ranging (LiDAR) module, a first light signal;
receiving, by a photodetector of a receiver circuit of the LiDAR module, a second light signal;
determining, by a controller of the LiDAR module, whether the second light signal includes a scatter signal coupled from the transmitter circuit, and a reflected first light signal; and
based on whether the second light signal includes the scatter signal and the reflected first light signal, determining a time-of-flight of the first light signal based on one of: a width of the second light signal, or a time difference between the transmission of the first light signal and the reception of the second light signal.

16. The method of claim 15, wherein the receiver circuit comprises an amplifier configured to convert a photocurrent signal output by the photodetector in response to the second light signal into a voltage signal;
wherein the width of the second light signal is determined based on a width of the voltage signal or based on a width of the photocurrent signal.

17. The method of claim 15, wherein the width of the second light signal is determined based on a threshold signal level; and
wherein the threshold signal level is based on a minimum signal level of the second light signal received from an object at a maximum distance for which the second light signal includes the scatter signal and the reflected first light signal.

18. The method of claim 15, further comprising:
determining a first width of the second light signal;
determining a second width of the scatter signal;
determining a degree of width change of the second light signal based on a difference between the first width and the second width; and
determining the time-of-flight based on the degree of width change.

19. The method of claim 15, further comprising:
receiving a third light signal corresponding to the scatter signal; and
determining a time difference between the third light signal and the second light signal for the time difference between the transmission of the first light signal and the reception of the second light signal.

20. The method of claim 15, further comprising:
determining that the second light signal includes the scatter signal but not the reflected first light signal; and
based on determining that the second light signal includes the scatter signal but not the reflected first light signal, transmitting, using the transmitter circuit, a third light signal;
wherein a signal level of the third light signal is higher than a signal level of the first light signal.
